(19) United States
(12) Patent Application Publication
(10) Pub. No.: US 2003/0110918 A1
(43) Pub. Date: Jun. 19, 2003

(54) Compass saw with tool receptacle

(76) Inventors: Konstanin Baxivanelis, Kaufering (DE); Andreas Dieterle, Wessling (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/319,246

(22) Filed: Dec. 13, 2002

(30) Foreign Application Priority Data
Dec. 17, 2001 (DE) 10161932.4

(51) Int. Cl. B26D 1/00

(52) U.S. Cl. 83/699.11; 83/697

(57) ABSTRACT

A compass saw comprising a motor-driven reciprocating rod (1) with a tool receptacle (2) disposed at its free end for receiving the clamping shaft (6) of a saw blade (3), a receiving hole (7) and a center bolt (19) that is pre-stressed towards the receiving hole (7), being guided transversely to the reciprocating rod (1) and displaceable in a longitudinal direction (L). The center bolt (19) comprises a centering means configured as a flat bearing surface (21). The bearing surface (21) cuts the longitudinal axis (A) of the reciprocating rod (1) into a slant angle (α).

### BACKGROUND OF THE INVENTION

The invention relates to a compass saw with a motor-driven reciprocating rod at whose free end a tool receptacle is provided for receiving a saw blade with a clamping shaft comprising a receiving hole and a centering bolt pre-stressed towards the receiving hole, transversely disposed to the reciprocating rod and displaceable in the longitudinal direction, said bolt having a centering means for centering the free end of the clamping shaft, which can be brought at least partially in contact with a narrow side of the clamping shaft.

Compass saws of the type described above have a tool receptacle for removably fastening a saw blade. The saw blade has a work zone comprising saw teeth and a clamping shaft that is received in the tool receptacle. The clamping shaft, despite varying saw blade thicknesses, must be immovably fastened in the tool receptacle of the compass saw to assure an exact cut in a workpiece.

DE 32 47 178 A1 discloses a compass saw with a reciprocating rod and a tool receptacle that can be operated without a tool for fastening a saw blade having a clamping shaft. The clamping shaft of the saw blade comprises two wide sides running parallel to each other and two narrow sides running parallel to each other, wherein two pins are disposed on each of the narrow sides. The tool receptacle arranged at the free end of the reciprocating rod comprises a receiving hole and a bore hole facing the receiving hole for the pre-stressed center bolt, which comprises centering means for centering the free end of the clamping shaft. The centering means is an open centering bore hole running in the longitudinal direction relative to the reciprocating rod and open facing the receiving hole, said centering bore cooperates partially with the edges formed by the narrow and wide sides point-wise.

The drawback in the known solution is that this solution requires a small manufacturing tolerance at the free end of the clamping shaft. If the manufacturing tolerances are not within the range, precise centering of the saw blade, especially of the clamping shaft, in the tool receptacle is no longer assured.

Furthermore, the manufacture of the known center bolt is not economical, because the configuration of the centering means makes several processing steps in the manufacture of the center bolt necessary.

### SUMMARY OF THE INVENTION

The object of the present invention is to provide a compass saw with a tool receptacle having a center bolt that is economical to manufacture and that assures precise fastening of a compass saw blade with different saw blade thicknesses.

This object is achieved, in accordance with the invention, by centering means having a flat bearing surface that intersects the longitudinal axis of the reciprocating rod at a slant angle.

The inventive configuration of the centering means as a bearing surface inclined towards the longitudinal axis results in centering of the clamping shaft in the tool receptacle that enables a precise centering of the saw blade independent of manufacturing quality. The free end of the clamping shaft is inserted into the receiving hole and is guided by the center bolt pre-stressed towards the receiving hole. The inclined surface formed by the bearing surface and the pre-stressing result in a force in the longitudinal direction and transverse to the reciprocating rod on the free end of the clamping shaft. As a result, the force acting between the center bolt and the clamping end is transferred to at least a portion of the narrow side of the clamping shaft by the bearing surface of the center bolt. The force is transferred by a contact point between the bearing surface and the narrow side of the clamping shaft. The force acting transversely to the longitudinal direction assures centering and the force acting in the longitudinal direction assures a longitudinal pre-stressing of the clamping shaft. The longitudinal pre-stressing can be used, for example, to fasten the saw blade in the area of the pins disposed on the two narrow sides by additional inclined surfaces.

Preferably, the slant angle is approximately 25° to 35° so that the slant angle of the bearing surface corresponds to that of the wedge-shaped free end of the clamping shaft. When this is done, the bearing surface acts, via a contact surface, with the clamping shaft and consequently permits optimal centering.

The bearing surface can, advantageously, be brought in point with the narrow side to allow precise centering in a clamping shaft that is not symmetrically formed. Point is defined as a superficial expansion.

Preferably, the bearing surface comprises a triangular recess with a base angle that runs along the longitudinal axis of the reciprocating rod and is inclined by approximately the slant angle. The recess assures an additional guide for the clamping shaft transverse to the reciprocating rod.

The base angle, preferably, corresponds to an angle of approximately 60° to assure optimal guiding of the clamping shaft through the recess.

The slant angle of the recess corresponds to an angle approximately between 25° to 35° and, thus, lies in the range of the slant angle of the bearing surface. Naturally, the slant angle of the recess can vary from that of the bearing surface but this has a negative affect on the economy of the tool receptacle.

### BRIEF DESCRIPTION OF THE INVENTION

The preferred exemplary embodiment of the invention will be more completely described below with reference to the following drawings, wherein:

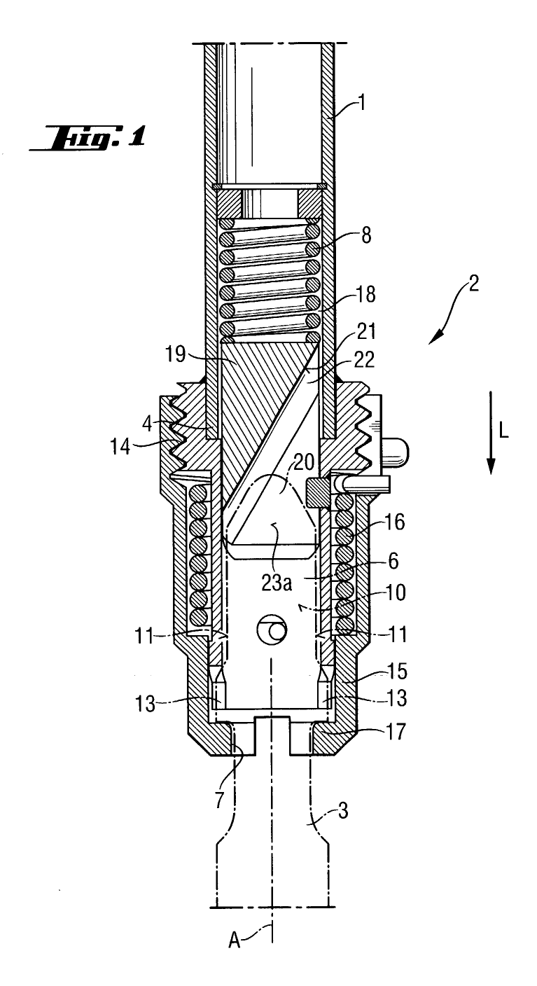

FIG. 1 shows a longitudinal section of a tool receptacle with a center bolt, in accordance with the invention;

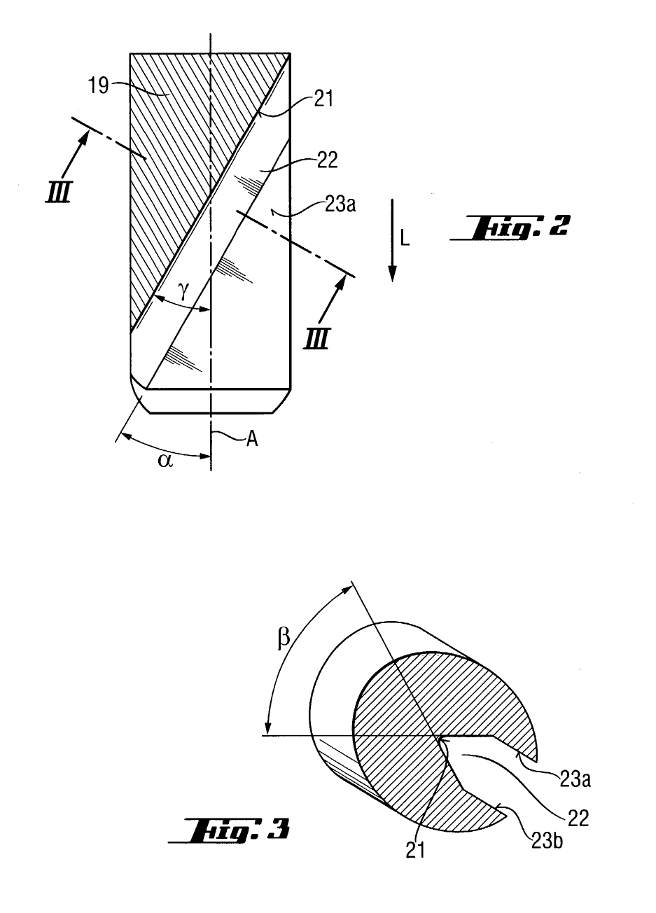

FIG. 2 shows an enlarged longitudinal section of the center bolt of FIG. 1; and

FIG. 3 represents a cross-section along the sectional line III-III of FIG. 2.

### DETAILED DESCRIPTION OF THE INVENTION

FIGS. 1 through 3 show a compass saw according to the invention comprising a motor-driven reciprocating rod 1 (shown in FIG. 1, in a partial cross-section ) with a tool receptacle 2 disposed at the free end of the rod 1. The tool receptacle 2 comprises a receiving hole 7 for receiving a clamping shaft 6 of a saw blade 3 and a center bolt 19 pre-stressed by a spring element 8 towards the receiving hole 7.

The clamping shaft 6 comprises two wide sides 10 running parallel to each other and two narrow sides 11 running at right angles thereto. A pin 13 is disposed on each of the narrow sides 11 and extends perpendicularly to the wide side 10.

The tool receptacle 2 comprises a longitudinally displaceable clamping sleeve 15 mounted on the reciprocating rod 1 by a thread 14. The clamping sleeve 15 is pre-stressed by a tensioning spring 16 relative to the reciprocating rod 1 such that, in the resting state, it is biased by the thread 14 against the free end 4 of the reciprocating rod 1. The potlike clamping sleeve 15 comprises a bottom part 17 with the receiving hole 7. In the resting state, the bottom part 17 forms a stop for the pin 13 of the inserted saw blade 3, as is shown particularly in FIG. 1.

The center bolt 19 moveable in the longitudinal direction L moves, in a bolt bore 18 running centrally in the longitudinal direction L open towards the free end 4, transverse to the reciprocating rod 1 and comprises a centering means for centering the free end 20 of the clamping shaft 6.

The centering means comprises a flat bearing surface 21 which cuts a longitudinal axis A of the reciprocating rod 1 into a slant angle α, as is shown particularly in FIG. 2. The slant angle α corresponds to an angle of approximately 30°. The bearing surface 21 can be brought in contact at a point or line with the narrow side 11 and comprises an triangular recess 22 running on an incline along the longitudinal axis A of the reciprocating rod 1 and the slant angle γ with a base angle β, as can be seen particularly in FIGS. 2 and 3. The slant angle γ of the recess 22 corresponds to the slant angle α of the bearing surface 21. The base angle β of the recess 22, which is particularly represented in FIG. 3, corresponds to an angle of approximately 60°.

The cylinder shaped center bolt 19 is, preferably, produced by a cut running at a slant angle of α almost centrally along the longitudinal axis of the reciprocating rod 1. Two walls 23a, 23b running parallel to the longitudinal axis of the reciprocating rod 1 are created by the cut and provide additional guiding aid when the saw blade 3 is being inserted into the tool receptacle 2.

What is claimed is:

1. A compass saw comprising a motor-driven reciprocating rod (1) with a tool receptacle (2) for receiving the clamping shaft (6) of a saw blade (3) disposed at a free end of the rod (1), a receiving hole (7) and a center bolt (19) pre-stressed towards the receiving hole (7), being guided transversely to the reciprocating rod (1) and displaceable in a longitudinal direction (L), the center bolt (19) comprising a centering means for centering a free end (20) of a clamping shaft (6), the centering means being brought at least partially in contact with a narrow side (11) of the clamping shaft (6), wherein the centering means comprises a flat bearing surface (21) which cuts a longitudinal axis (A) of the reciprocating rod (1) into a slant angle (α).

2. The compass saw of claim 1, wherein the slant angle (α) is an angle approximately between 25° to 35°.

3. The compass saw of claim 1, wherein the bearing surface (21) is in contact, in a point, with the narrow side (11).

4. The compass saw of claim 1, wherein the bearing surface (21) comprises a triangular recess (22) with a base angle (β) running along the longitudinal axis (A) of the reciprocating rod (1) and inclined at a second slant angle (γ).

5. The compass saw of claim 4, wherein the base angle (β) is approximately 60°.

6. The compass saw of claim 4, wherein the second slant angle (γ) is an angle approximately between 25° to 35°.
